(19) United States
(12) Patent Application Publication
(10) Pub. No.: US 2011/0019281 A1
(43) Pub. Date: Jan. 27, 2011

(54) IMAGING OPTICAL SYSTEM AND IMAGING DEVICE USING THE SAME

(75) Inventors: Takumi Iba, Kyoto (JP); Masatoshi Yamashita, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/934,553

(22) PCT Filed: Aug. 5, 2009
(86) PCT No.: PCT/JP2009/003752

§ 371 Date: Sep. 24, 2010

(30) Foreign Application Priority Data
Nov. 13, 2008 (JP) 2008-291203

(51) Int. Cl. G02B 17/00

(52) U.S. Cl. 359/613

(57) ABSTRACT

An imaging optical system capable of sufficiently suppressing the occurrence of flare or ghost that degrade the image quality is provided. The imaging optical system is an imaging optical system 7 that includes an aperture stop 5, and first to fourth lenses 1 to 4 as optical members, which are arranged in that order from an object side to an image plane side. The first lens 1 is a biconvex lens having a positive power. The second lens 2 is formed of a meniscus lens that has a negative power and has a concave lens surface on the image plane side. The third lens 3 is formed of a meniscus lens that has a positive power and has a convex lens surface on the image plane side. The fourth lens 4 has a negative power and has a lens surface on the image plane side that is concave in the vicinity of an optical axis. On an effective aperture part of an image-plane-side lens surface e of the second lens 2, a total reflection surface is provided that subjects incident light beams that are incident at angles out of the angle of view to total reflection.

### TECHNICAL FIELD

The present invention relates to an imaging optical system that forms an image of a subject on an imaging part (e.g., an imaging surface of an imaging element) by using optical members (e.g., optical lenses, a parallel plate), and also relates to an imaging device using the imaging optical system.

### BACKGROUND ART

In such an imaging optical system, unwanted light flux (stray light) that does not contribute to the image formation exists, which is a so-called “flare” or “ghost”, which degrades the image quality. A main cause for this unwanted light flux is as follows: an incident light beam that is incident at an angle out of the angle of view is reflected by a lens surface or an edge part of an optical lens and reaches an imaging surface of an imaging element.

Conventionally the following has been proposed as a means for preventing the degradation of image quality owing to such flare or ghost (see, e.g., Patent Documents 1 to 3).

More specifically, Patent Document 1 proposes an annular flare stopper that is incorporated in a lens barrel for holding optical lenses, and that allows light beams entering the optical lens to pass through a circular opening at the center, so as to suppress the occurrence of flare, wherein an edge surface of the circular opening is tilted with respect to an optical axis for imaging.

Patent Document 2 proposes a stray light preventing structure in which a light-blocking plate is provided in a lens barrel so as to prevent stray light from being transmitted.

Further, Patent Document 3 proposes a lens for imaging in which a second diaphragm is inserted so as to cut flare.

### PRIOR ART DOCUMENT

### Patent Document

Patent Document 1: JP 3891567 B

Patent Document 2: JP 2001-242365 A

Patent Document 3: JP 3396683 B

### DISCLOSURE OF THE INVENTION

### Problem to be Solved by the Invention

Even if a flare stopper, etc., is provided as is the case with Patent Documents 1 to 3, the usual lens design alone is not enough to suppress sufficiently the occurrence of flare or ghost that degrades the image quality.

The present invention was made in order to solve the aforementioned problem in the prior art, and an object of the present invention is to provide an imaging optical system that is capable of sufficiently suppressing the occurrence of flare or ghost that degrades the image quality, and to provide an imaging device using the aforementioned imaging optical system.

### Means for Solving Problem

In order to achieve the aforementioned object, the imaging optical system according to the present invention is an imaging optical system that allows light beams incident from an object side to outgo to an image plane side so as to form an image of a subject on an imaging part, wherein an incident light beam that is incident at an angle out of an angle of view is blocked by total reflection by an optical member.

With the above-described configuration of the imaging optical system according to the present invention, the incident light beam that is incident at an angle out of the angle of view is blocked by total reflection by an optical member, and unwanted light flux at an angle out of the angle of view can be prevented from reaching the imaging part. As a result, the occurrence of flare or ghost that degrades the image quality can be suppressed sufficiently.

In the configuration of the imaging optical system according to the present invention, preferably, a total reflection surface of the optical member that subjects the incident light beam that is incident at the angle out of the angle of view to total reflection is provided on an effective aperture part of an optical surface. With this preferable example, unwanted light flux incident at an angle out of the angle of view can be blocked effectively.

Further, in the configuration of the imaging optical system according to the present invention, preferably, a total reflection surface of the optical member that subjects the incident light beam that is incident at the angle out of the angle of view to total reflection is provided outside an effective aperture part of an optical surface. With this preferable example, the occurrence of flare or ghost that degrades the image quality can be suppressed sufficiently, while free designing of an effective aperture part of an optical surface is enabled. Further, if a total reflection surface that subjects incident light beams that are incident at angles out of the angle of view to total reflection is provided also on the effective aperture part of the optical surface, the effect of suppressing the occurrence of flare or ghost that degrades the image quality can be improved further.

Still further, in the configuration of the imaging optical system according to the present invention, preferably, a total reflection surface of the optical member, which subjects the incident light beam that is incident at the angle out of the angle of view to total reflection, has a convex shape with respect to the incident light beam.

Still further, in the configuration of the imaging optical system according to the present invention, preferably, a total reflection surface of the optical member, which subjects the incident light beam that is incident at the angle out of the angle of view to total reflection, is provided obliquely with respect to the incident light beam.

Still further, in the configuration of the imaging optical system according to the present invention, preferably, a means for preventing a light beam reflected by a total reflection surface from reaching the imaging part is provided at a part that the light beam reflected by the total reflection surface reaches, the total reflection surface subjecting the incident light beam that is incident at the angle out of the angle of view to total reflection. With this preferable example, it is possible to prevent flare or ghost that degrades the image quality from occurring. Further, in this case, preferably, the means for preventing the light beam reflected by the total reflection surface from reaching the imaging part is formed of an antireflection structure or a diffusion structure. With this preferable example, it is possible to prevent a part of the light beam subjected to total reflection from being reflected further by another part and reaching the imaging part. Further, in this case, preferably, the means for preventing the light beam reflected by the total reflection surface from reaching the imaging part is provided on the optical member. With this preferable example, the present invention including the means for preventing the light beam reflected by the total reflection surface from reaching the imaging part can be completed at a step of processing the optical member.

Still further, an imaging device according to the present invention is an imaging device that includes: an imaging element that converts an optical signal corresponding to a subject into an image signal and outputs the image signal; and an imaging optical system that forms an image of the subject on an imaging surface of the imaging element, wherein, as the imaging optical system, the imaging optical system according to the present invention is used.

With the above-described configuration of the imaging device according to the present invention, an imaging optical system according to the present invention is used as the imaging optical system, whereby the occurrence of flare or ghost that degrades the image quality can be suppressed sufficiently. Therefore, it is possible to provide a high-performance imaging device, and moreover, to provide mobile products such as a high-performance portable telephone in which the above-described imaging device is incorporated.

### EFFECTS OF THE INVENTION

As described above, with the present invention, it is possible to provide an imaging optical system that is capable of sufficiently suppressing the occurrence of flare or ghost that degrades the image quality and is compatible with an imaging element incorporated in a mobile product such as a mobile telephone with a camera, and to provide an imaging device in which the foregoing imaging optical system is used.

### BRIEF DESCRIPTION OF DRAWINGS

FIG. 1 is a diagram showing the layout of an imaging optical system according to Embodiment 1 of the present invention.

FIG. 2 is a diagram showing the layout of an imaging optical system according to Embodiment 2 of the present invention.

### DESCRIPTION OF THE INVENTION

The following describes the present invention in more detail by referring to embodiments of the same.

### Embodiment 1

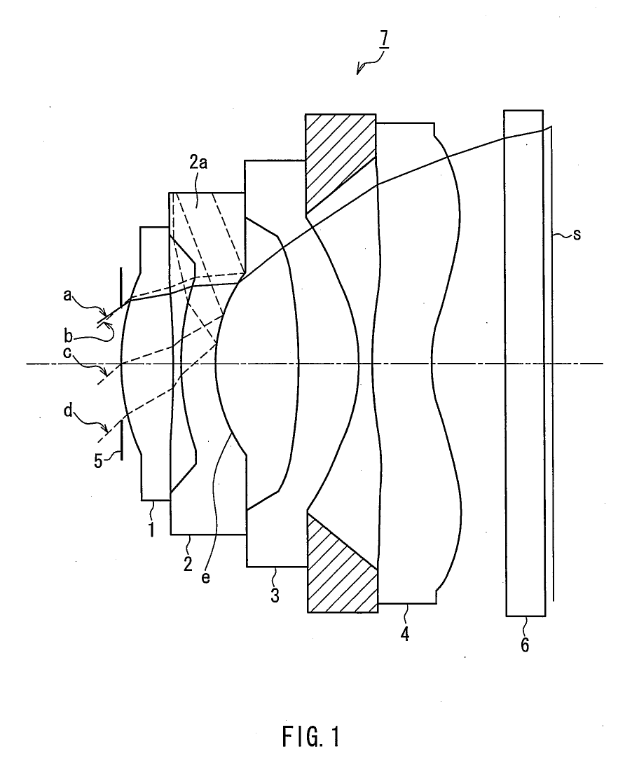

FIG. 1 is a diagram showing a layout of an imaging optical system according to Embodiment 1 of the present invention.

[1. Configuration of Imaging Optical System]

First, a configuration of an imaging optical system according to the present embodiment is described.

As shown in FIG. 1, an imaging optical system 7 according to the present embodiment includes an aperture stop 5, and first to fourth lenses 1 to 4 as optical members, which are arranged in that order from an object side (left side in FIG. 1) to an image plane side (right side in FIG. 1). The first lens 1 is a biconvex lens having a positive power. The second lens 2 is formed of a meniscus lens that has a negative power and has a concave lens surface on the image plane side. The third lens 3 is formed of a meniscus lens that has a positive power and has a convex lens surface on the image plane side. The fourth lens 4 has a negative power and has a lens surface on the image plane side that is concave in the vicinity of an optical axis. Here, the imaging optical system 7 is a single focal length lens for the purpose of imaging that allows light beams incident from the object side to outgo to the image plane side, thereby forming an optical image (forming an image of a subject) on an imaging part (in the present embodiment, an imaging surface S of an imaging element), and the imaging element converts an optical signal corresponding to the subject into an image signal and outputs the image signal. The imaging element and the imaging optical system 7 in combination form an imaging device.

Each lens surface of the first to fourth lenses 1 to 4 may be formed into an aspherical shape as appropriate, and the aspherical shape of each lens surface is given as Formula 1 below (this applies to Embodiment 2 described later):

$$X = \frac{\frac{{Y}^{2}}{{R}_{0}}}{1 + \sqrt{1 - ( κ + 1 ) {( \frac{Y}{{R}_{0}} )}^{2}}} + A 4 {Y}^{4} + A 6 {Y}^{6} + A 8 {Y}^{8} + A 10 {Y}^{10} + … \qquad [ Formula 1 ]$$

In the above formula 1, “Y” represents a height from the optical axis, “X” represents a distance from a tangentical plane to a vertex of an aspherical surface of an aspherical shape at the height “Y” from the optical axis, “R₀” represents a radius of curvature of the vertex of the aspherical surface, “κ” represents a conic constant, and “A4”, “A6”, “A8”, “A10” . . . represent fourth-order, sixth-order, eighth-order, tenth-order . . . aspherical coefficients, respectively.

Between the fourth lens 4 and the imaging surface S of the imaging element, a transparent parallel plate 6 is provided. Here, the parallel plate 6 is a plate equivalent to an optical low-pass filter, an IR cut filter, and a face plate (cover glass) of the imaging element.

Hereinafter, the surfaces (hereinafter referred to as “optical surfaces” as well in some cases) of the lenses 1 to 4 and the parallel plate 6, from the object-side lens surface of the first lens 1 to the image-plane-side surface of the parallel plate 6, are referred to as “first surface”, “second surface”, “third surface”, . . . “tenth surface”, respectively, in that order from the object side (this applies to Embodiment 2 described later).

Specific examples of the numerical values of the imaging optical system 7 according to the present embodiment are shown in Table 1 below.

TABLE 1

| Surface No. | r (mm) | d (mm) | n | ν |
|---|---|---|---|---|
| Aperture stop | ∞ | 0.00 | — | — |
| First surface | 2.193 | 0.60 | 1.4845 | 70.2 |
| Second surface | −13.5 | 0.10 | — | — |
| Third surface | 3.053 | 0.44 | 1.61 | 27.0 |
| Fourth surface | 1.718 | 1.13 | — | — |
| Fifth surface | −5.036 | 0.76 | 1.525 | 56.4 |
| Six surface | −1.551 | 0.22 | — | — |
| Seventh surface | 4.049 | 0.71 | 1.525 | 56.4 |
| Eighth surface | 1.348 | 1.00 | — | — |
| Ninth surface | ∞ | 0.50 | 1.5168 | 64.2 |
| Tenth surface | ∞ | 0.05 | — | — |
| Imaging surface | ∞ | — | — | — |

In Table 1 above, the column of “r (mm)” shows radii of curvature of the optical surfaces, the column of “d (mm)” shows thicknesses of and distances between the surfaces of the first to fourth lenses 1 to 4 and the parallel plate 6 on the axis, the column of “n” shows refractive indices with respect to the d line (587.5600 nm) of the first to fourth lenses 1 to 4 and the parallel plate 6, and the column of “v” shows Abbe's numbers with respect to the d line of the first to fourth lenses 1 to 4 and the parallel plate 6 (this applies to Embodiment 2 described later).

Further, Tables 2A and 2B below show aspherical coefficients (including conic constants) of the first to fourth lenses 1 to 4 forming the imaging optical system 7 according to the present embodiment. In Tables 2A and 2B below, “E+00”, “E-02”, etc. show “10⁺⁰⁰”, “10⁻⁰²”, etc., respectively (this applies to Embodiment 2 described later).

TABLE 2A

| | κ | A4 | A6 |
|---|---|---|---|
| First surface | −3.319E−01 | −5.470E−03 | −1.130E−02 |
| Second surface | 0.000E+00 | −1.118E−02 | 1.500E−02 |
| Third surface | −3.315E−01 | −2.739E−02 | 1.798E−02 |
| Fourth surface | −2.056E+00 | 1.891E−02 | −2.512E−03 |
| Fifth surface | −2.270E+01 | 1.595E−02 | −1.874E−02 |
| Six surface | −4.986E+00 | −2.491E−02 | 1.720E−02 |
| Seventh surface | −2.334E+00 | −6.199E−02 | 1.392E−02 |
| Eighth surface | −5.152E+00 | −4.259E−02 | 1.017E−02 |

TABLE 2B

| | A8 | A10 | A12 |
|---|---|---|---|
| First surface | 1.599E−02 | −1.465E−02 | 0.000E+00 |
| Second surface | 2.035E−02 | −2.437E−02 | 0.000E+00 |
| Third surface | 3.676E−02 | −2.193E−02 | −3.655E−03 |
| Fourth surface | 2.069E−02 | 1.298E−02 | −1.467E−02 |
| Fifth surface | 3.625E−03 | −7.851E−04 | 5.318E−05 |
| Six surface | −1.017E−02 | 3.597E−03 | −5.009E−04 |
| Seventh surface | −4.860E−04 | −1.245E−04 | 9.407E−06 |
| Eighth surface | −2.003E−03 | 2.270E−04 | −1.077E−05 |

The imaging optical system 7 according to the present embodiment has a configuration such that light beams incident at an angle out of the angle of view are blocked by total reflection by optical members. More specifically, a total reflection surface that subjects light beams incident at an angle out of the angle of view to total reflection is provided at an effective aperture part of an image-plane-side lens surface e of the second lens 2. In other words, the image-plane-side lens surface e of the second lens 2 is an optical surface having an area with a larger refractive index on the object side (the second lens 2 has a refractive index n₁ of 1.61, and air between the second and third lenses 2 and 3 has a refractive index of 1.00), and a critical angle as an angle of incidence at which total reflection starts occurring is sin⁻¹(1/n₁)=about 38°. Further, the image-plane-side lens surface e of the second lens 2 (total reflection surface) is in a convex shape with respect to incident light beams (a shape convex toward the object side), and has a radius of curvature r₁ of 1.718 mm.

[2. Operational Effects of Imaging Optical System]

Next, operational effects of the imaging optical system having the above-described configuration are explained.

In FIG. 1, “a”, “b”, “c”, and “d” denote light beams entering the imaging optical system 7.

The light beam a (solid line) enters the imaging optical system 7 at an angle of incidence of about 32°, is one of the light beams that form an image on the imaging surface S, and passes respective apertures of the largest effective diameters of the first to fourth lenses 1 to 4.

The light beams b, c, and d (broken lines) enter the imaging optical system 7 at angles of incidence of about 40° (>half angle of view ω₁=about 32.5°), which are greater than that of the light beam a, and do not contribute to the image formation (unwanted light flux) (the light beam b is a light beam at an upper end of the unwanted light flux (upper light beam), the light beam c is a light beam passing through the center of the aperture stop 5 of the unwanted light flux (principal light beam), and the light beam d is a light beam at a lower end of the unwanted light flux (lower light beam)). When the light beams b, c, and d are incident on the image-plane-side lens surface e of the second lens 2, the angles of incidence of the light beams b, c, and d with respect to the image-plane-side lens surface e of the second lens 2 exceed the critical angle, and the light beams b, c, and d are subjected to total reflection at the image-plane-side lens surface e of the second lens 2. In other words, the light beams b, c, and d are blocked by total reflection at the image-plane-side lens surface e of the second lens 2. Thus, it is possible to prevent the light beams b, c, and d from reaching the imaging surface S, thereby sufficiently suppressing the occurrence of flare or ghost that degrades the image quality.

Here, the light beams b, c, and d subjected to total reflection at the image-plane-side lens surface e of the second lens 2 reach outer surfaces (front surface, outer peripheral surface) of the edge part 2a of the second lens 2. If a means for preventing the light beams b, c, and d reflected by the image-plane-side lens surface e (total reflection surface) of the second lens 2 from reaching the imaging surface S is provided on the outer surfaces of the edge part 2a of the second lens 2, the occurrence of flare or ghost that degrades the image quality can be prevented.

Examples of the means for preventing the light beams b, c, and d reflected by total reflection surface from reaching the imaging surface S include an antireflection structure or a diffusion structure. To achieve the antireflection structure, for example, an antireflection paint may be applied, or a light-blocking sheet may be provided. To achieve the diffusion structure, for example, an irregular surface may be formed by embossing, or regular projections and recesses may be formed. If such a structure is used as a means for preventing the light beams b, c, and d reflected by the total reflection surface from reaching the imaging surface S, it is possible to prevent a part of the light beams b, c, and d subjected to total reflection from being reflected further by another part and reaching the imaging surface S.

Further, if the means for preventing the light beams b, c, and d reflected by the image-plane-side lens surface e (total reflection surface) of the second lens 2 (optical member) from reaching the imaging surface S is provided on the outer surfaces of the edge part 2a of the second lens 2 (optical member), the present invention including the means for preventing the light beams b, c, and d reflected by the total reflection surface from reaching the imaging surface S can be completed at a step of processing the second lens 2 (optical member). It should be noted that the means for preventing the light beams reflected by total reflection surface from reaching the imaging surface S may be provided on an optical member (the third lens 3, the parallel plate 6, etc.) other than the optical member on which the total reflection surface is provided (in the present embodiment, the second lens 2).

Further, giving consideration to light beams having passed through the second lens 2 reaching a member holding the lenses (lens holding member), the same antireflection structure or diffusion structure as described above may be provided on the lens holding member, whereby, in the same way as in the case described above, a part of the light beams b, c, and d subjected to total reflection at the image-plane-side lens surface e of the second lens 2 is prevented from being reflected further by another part and thereby reaching the imaging surface S.

The part that the light beams b, c, and d subjected to total reflection reach, as described above, can be determined by optical path analysis (light beam tracking simulation).

It should be noted that in the present embodiment, a total reflection surface is provided on the second lens 2, but the total reflection surface may be provided on any one of the optical members (in the present embodiment, the total reflection surface may be provided on any one of the first to fourth lenses 1 to 4).

### Embodiment 2

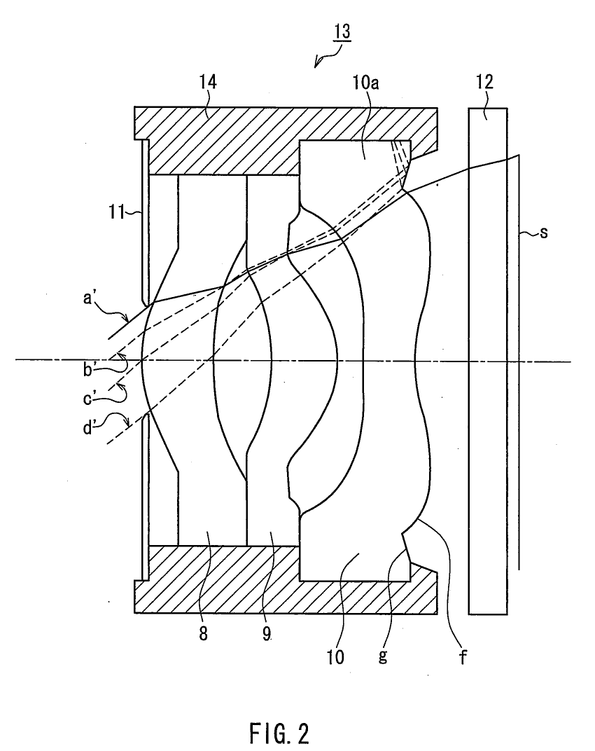

FIG. 2 is a diagram showing a layout of an imaging optical system according to Embodiment 2 of the present invention.

[1. Configuration of Imaging Optical System]

First, a configuration of an imaging optical system according to the present embodiment is explained.

As shown in FIG. 2, an imaging optical system 13 according to the present embodiment includes an aperture stop 11, and first to third lenses 8 to 10 as optical members, which are arranged in that order from an object side (left side in FIG. 2) to an image plane side (right side in FIG. 2). The first lens 8 is formed of a meniscus lens that has a positive power and has a concave lens surface on the image plane side. The second lens 9 is formed of a meniscus lens that has a positive power and has a convex lens surface on the image plane side. The third lens 10 has a negative power and has a lens surface on the image plane side that is concave in the vicinity of an optical axis. These lenses are held by a lens holding member 14. Here, the imaging optical system 13 is a single focal length lens for the imaging purpose that allows light beams incident from the object side to outgo to the image plane side, thereby forming an optical image (forming an image of a subject) on an imaging part (in the present embodiment, an imaging surface S of an imaging element), and the imaging element converts an optical signal corresponding to the subject into an image signal and outputs the image signal. The imaging element and the imaging optical system 13 in combination form an imaging device.

A transparent parallel plate 12, like the parallel plate 6 in Embodiment 1 described above, is provided between the third lens 10 and the imaging surface S of the imaging element.

Specific examples of the numerical values of the imaging optical system 13 according to the present embodiment are shown in Table 3 below.

TABLE 3

| Surface No. | r (mm) | d (mm) | n | ν |
|---|---|---|---|---|
| Aperture stop | ∞ | 0.00 | — | — |
| First surface | 1.981 | 0.97 | 1.525 | 56.4 |
| Second surface | 13.160 | 0.75 | — | — |
| Third surface | −1.849 | 0.71 | 1.525 | 56.4 |
| Fourth surface | −0.990 | 0.32 | — | — |
| Fifth surface | −46.820 | 0.69 | 1.525 | 56.4 |
| Six surface | 1.474 | 0.70 | — | — |
| Seventh surface | ∞ | 0.50 | 1.5168 | 64.2 |
| Eighth surface | ∞ | 0.05 | — | — |
| Imaging surface | ∞ | — | — | — |

Further, Tables 4A and 4B below show aspherical coefficients (including conic constants) of the first to third lenses 8 to 10 forming the imaging optical system 13 according to the present embodiment.

TABLE 4A

| | κ | A4 | A6 |
|---|---|---|---|
| First surface | −1.597E+00 | 2.277E−02 | 1.903E−04 |
| Second surface | 0.000E+00 | 1.259E−02 | −7.626E−03 |
| Third surface | −8.704E+00 | −1.953E−01 | 1.021E−01 |
| Fourth surface | −2.829E+00 | −1.569E−01 | 7.154E−02 |
| Fifth surface | 0.000E+00 | −1.082E−01 | 3.143E−02 |
| Six surface | −7.352E+00 | −7.102E−02 | 1.901E−02 |

TABLE 4B

| | A8 | A10 | A12 |
|---|---|---|---|
| First surface | −4.191E−02 | 2.200E−01 | −3.651E−01 |
| Second surface | −9.705E−03 | 2.384E−02 | −1.861E−02 |
| Third surface | −5.910E−02 | 5.954E−02 | −1.483E−02 |
| Fourth surface | −2.438E−02 | 7.679E−03 | 4.756E−03 |
| Fifth surface | −1.803E−02 | 9.638E−03 | −4.293E−03 |
| Six surface | −5.078E−03 | 4.104E−04 | −5.008E−06 |

The imaging optical system 13 according to the present embodiment also has a configuration such that light beams incident at an angle out of the angle of view are blocked by total reflection by an optical member. More specifically, a total reflection surface that subjects light beams incident at an angle out of the angle of view to total reflection is provided at a surface g outside an effective aperture part of an image-plane-side lens surface f of the third lens 10 (an image-plane-side surface of an edge part 10a). In other words, the surface g outside the effective aperture part of the image-plane-side lens surface f of the third lens 10 is a surface having an area with a larger refractive index on the object side (the third lens 10 has a refractive index n₂ of 1.525, and air between the third lens 10 and the parallel plate 12 has a refractive index of 1.00), and a critical angle as an angle of incidence at which total reflection starts occurring is sin⁻¹(1/n₂)=about 41°. Further, the surface g (total reflection surface) is inclined so that a distance between the surface g and the imaging surface S decreases as the distance from the optical axis increases (the surface g is provided with a tilt with respect to incident light beams). Here, an angle θ₂ formed between the surface g and a plane perpendicular to the optical axis is about 20°. In this case, the surface g should be arranged appropriately according to optical path analysis.

[2. Operational Effects of Imaging Optical System]

Next, operational effects of the imaging optical system having the above-described configuration are explained.

In FIG. 2, “a”, “b′”, “c”, and “d” denote light beams entering the imaging optical system 13.

The light beam a′ (solid line) enters the imaging optical system 13 at an angle of incidence of about 32°, is one of the light beams that form an image on the imaging surface S, and passes respective apertures of the largest effective diameters of the first to third lenses 8 to 10.

The light beams b′, c′, and d′ (broken lines) enter the imaging optical system 13 at angles of incidence of about 40° (>half angle of view ω₂=about 32°), which are greater than that of the light beam a′, and do not contribute to the image formation (unwanted light flux) (the light beam b′ is a light beam at an upper end of the unwanted light flux (upper light beam), the light beam c′ is a light beam passing through the center of the aperture stop 11 of the unwanted light flux (principal light beam), and the light beam d′ is a light beam at a lower end of the unwanted light flux (lower light beam)). When the light beams b′, c′, and d′ are incident on a surface g outside the effective aperture part of the image-plane-side lens surface f of the third lens 10, the angles of incidence of the light beams b′, c′, and d′ with respect to the surface g exceed the critical angle, and the light beams b′, c′, and d′ are subjected to total reflection at the surface g. In other words, the light beams b′, c′, and d′ are blocked by total reflection at the surface g. Thus, it is possible to prevent the light beams b′, c′, and d′ from reaching the imaging surface S, thereby sufficiently suppressing the occurrence of flare or ghost that degrades the image quality. It should be noted that if a total reflection surface for totally reflecting the light beams that are incident at angles out of the angle of view is provided also at an effective aperture part of a lens surface, it is possible further to improve the effect of suppressing the occurrence of flare or ghost that degrades the image quality.

Here, the light beams b′, c′, and d′ subjected to total reflection at the surface g of the third lens 10 (optical member) reach outer peripheral surfaces of the edge part 10a of the third lens 10. If a means for preventing the light beams b′, c′, and d′ reflected by the surface g (total reflection surface) from reaching the imaging surface S, like the means in Embodiment 1, is provided on the outer peripheral surfaces of the edge part 10a of the third lens 10 (optical member), for example, it is possible to prevent a part of the light beams b′, c′, and d′ subjected to total reflection from being reflected further by another part and reaching the imaging surface S. It should be noted that in the present embodiment as well, the means for preventing the light beams reflected by the total reflection surface from reaching the imaging surface S may be provided on an optical member (the second lens 9, the parallel plate 12, etc.) other than the optical member on which the total reflection surface is provided (in the present embodiment, the third lens 10). For example, though not illustrated in the drawing, in the case where the light beams b′, c′, and d′ reflected by total reflection at the surface g of the third lens 10 are reflected by the lens holding member 14 and the reflected light beams reach the surface of the edge part of the second lens 9, an antireflection structure or a diffusion structure may be provided on the surface of the edge part of the second lens 9, whereby the light beams reflected by the total reflection surface are prevented from reaching the imaging surface S.

Further, with consideration given to that light beams having passed through the third lens 10 reach the lens holding member 14, the same structure as described above may be provided on the lens holding member 14, whereby, in the same way as in the case described above, a part of the light beams b′, c′, and d′ subjected to total reflection at the surface g is prevented from being reflected further by another part thereby reaching the imaging surface S.

It should be noted that in the present embodiment, a total reflection surface is provided on the image-plane-side surface of the edge part of the third lens 10 (the surface outside the effective aperture part of the lens surface), but the total reflection surface may be provided on any one of the optical members (in the present embodiment, the total reflection surface may be provided on any one of the first to third lenses 8 to 10).

Further, the present embodiment is described with reference to, as an example, the total reflection surface that is inclined so that the distance between the total reflection surface and the imaging surface S decreases as the distance from the optical axis increases, but the present invention is not limited to such a configuration. The total reflection surface may be oblique with respect to the incident light beams, and therefore the total reflection surface may be formed perpendicularly with respect to the optical axis, or may be inclined so that the distance between the total reflection surface and the imaging surface S increases as the distance from the optical axis increases.

Further, though the present embodiment is described with reference to a case where the total reflection surface is provided obliquely with respect to the incident light beams as described above, the total reflections surface in this case may be in a convex shape with respect to the incident light beams, as is the case with Embodiment 1 described above.

Still further, Embodiments 1 and 2 are described with reference to a case where the imaging optical system is a single focal length lens, but the present invention is applicable to an imaging optical system having a zooming function. Still further, the invention in which Embodiments 1 and 2 are combined is applicable also to an imaging optical system formed of a single focal length lens, and to an imaging optical system having a zooming function as well.

### INDUSTRIAL APPLICABILITY

Since the imaging optical system of the present invention is capable of sufficiently suppressing flare or ghost that degrades the image quality, the imaging optical system of the present invention is particularly useful in the field of mobile products such as a mobile telephone with a camera where high performance is desired.

### DESCRIPTION OF REFERENCE CODES

a, b, c, d, a′, b′, c′, d′ light beam
e lens surface (total reflection surface)
f lens surface
g surface (total reflection surface)
S imaging surface
1, 8 first lens
2, 9 second lens
2a, 10a edge part
3, 10 third lens
4 fourth lens
5, 11 aperture stop
6 parallel plate
7, 13 imaging optical system

1. An imaging optical system that allows light beams incident from an object side to outgo to an image plane side so as to form an image of a subject on an imaging part,
wherein a total reflection surface of a member having a lens part or a parallel plate is provided on an effective aperture part of an optical surface, the total reflection surface of the member subjecting incident light beam that is incident at an angle out of an angle of view to total reflection, whereby the incident light beam that is incident at the angle out of the angle of view is blocked by total reflection by the member.

2. (canceled)

3. An imaging optical system that allows light beams incident from an object side to outgo to an image plane side so as to form an image of a subject on an imaging part,
wherein a total reflection surface of a member having a lens part or a parallel plate is provided outside an effective aperture part of an optical surface, the total reflection surface of the member subjecting incident light beam that is incident at an angle out of an angle of view to total reflection, whereby the incident light beam that is incident at the angle out of the angle of view is blocked by total reflection by the member, and
the total reflection surface of the member, which subjects the incident light beam that is incident at the angle out of the angle of view to total reflection, has either a shape convex with respect to the incident light beam, or an inclined surface that is inclined so that a distance between the inclined surface and the imaging part decreases as a distance from an optical axis increases.

4. The imaging optical system according to claim 1, wherein a total reflection surface of the member, which subjects the incident light beam that is incident at the angle out of the angle of view to total reflection, has a shape convex with respect to the incident light beam.

5. (canceled)

6. The imaging optical system according to claim 1, wherein a means for preventing a light beam reflected by a total reflection surface from reaching the imaging part is provided at a part that the light beam reflected by the total reflection surface reaches, the total reflection surface subjecting the incident light beam that is incident at the angle out of the angle of view to total reflection.

7. The imaging optical system according to claim 6, wherein the means for preventing the light beam reflected by the total reflection surface from reaching the imaging part is formed of an antireflection structure or a diffusion structure.

8. The imaging optical system according to claim 6, wherein the means for preventing the light beam reflected by the total reflection surface from reaching the imaging part is provided on the member.

9. An imaging device comprising:
an imaging element that converts an optical signal corresponding to a subject into an image signal and outputs the image signal; and
an imaging optical system that forms an image of the subject on an imaging surface of the imaging element,
wherein, as the imaging optical system, the imaging optical system according to claim 1 is used.

10. The imaging optical system according to claim 3, wherein a means for preventing a light beam reflected by a total reflection surface from reaching the imaging part is provided at a part that the light beam reflected by the total reflection surface reaches, the total reflection surface subjecting the incident light beam that is incident at the angle out of the angle of view to total reflection.

11. The imaging optical system according to claim 10, wherein the means for preventing the light beam reflected by the total reflection surface from reaching the imaging part is formed of an antireflection structure or a diffusion structure.

12. The imaging optical system according to claim 10, wherein the means for preventing the light beam reflected by the total reflection surface from reaching the imaging part is provided on the member.

13. An imaging device comprising:
an imaging element that converts an optical signal corresponding to a subject into an image signal and outputs the image signal; and
an imaging optical system that forms an image of the subject on an imaging surface of the imaging element,
wherein, as the imaging optical system, the imaging optical system according to claim 3 is used.
